(19) United States
(12) Patent Application Publication
(10) Pub. No.: US 2015/0197150 A1
(43) Pub. Date: Jul. 16, 2015

(54) VEHICLE SOLAR CELL PANEL

(71) Applicant: TOYOTA JIDOSHA KABUSHIKI KAISHA, Toyota-shi (JP)

(72) Inventor: Yasuhiro SHIRAI, Toyota-shi (JP)

(21) Appl. No.: 14/586,372

(22) Filed: Dec. 30, 2014

(30) Foreign Application Priority Data
Jan. 15, 2014 (JP) 2014-005224

(51) Int. Cl. B60K 16/00; H02S 30/10; H02S 20/30

(52) U.S. Cl. CPC B60K 16/00; H02S 20/30; H02S 30/10; B60K 2016/003

(57) ABSTRACT

A vehicle solar cell panel that is mounted to a vehicle provided with a roof rail includes a flange portion formed by a side edge portion of at least a portion of the vehicle solar cell panel being bent back toward a back side of a light receiving surface. A roof panel of the vehicle is formed by the flange portion being attached to the roof rail.

### INCORPORATION BY REFERENCE

The disclosure of Japanese Patent Application No. 2014-005224 filed on Jan. 15, 2014 including the specification, drawings and abstract is incorporated herein by reference in its entirety.

### BACKGROUND OF THE INVENTION

1. Field of the Invention

The invention relates to the structure of a vehicle solar cell panel to be installed in a vehicle.

2. Description of Related Art

Japanese Patent Application Publication No. 10-181483 (JP 10-181483 A) describes technology related to a solar cell installed in a vehicle. The solar cell described in JP 10-181483 A is formed in a flat plate shape with solar cell elements stacked on a flexible circuit board. A rubber or resin terminal member is attached to an outer edge portion of this solar cell. Also, the solar cell is mounted to a surface of a roof panel of the vehicle with an adhesive or a magnet, while being supported by the terminal member.

Also, Japanese Patent Application Publication No. 11-240397 (JP 11-240397 A) describes technology related to a mounting member of a vehicle solar cell. The mounting structure of a solar cell described in JP 11-240397 A is a member that attaches to an outer edge portion of a flat plate-like solar cell, and is formed by a strip-shaped elastic member made of rubber or resin. Also, the solar cell described in JP 11-240397 A is also adhered to a surface of a roof panel of a vehicle by double-faced adhesive tape, while being supported by the mounting member, similar to the structure described in JP 10-181483 A.

A solar cell can easily be mounted to a vehicle by affixing the solar cell to the surface of the roof panel using, for example, double-faced tape, an adhesive, or a magnet or the like, like the structures described in JP 10-181483 A and JP 11-240397 A. However, with this kind of structure, a solar cell is simply added to the vehicle, so the number of parts, vehicle weight, and manufacturing cost and the like are all greater than they are with an existing vehicle.

In contrast to this kind of structure, it is possible to avoid duplication of a member of a roof portion by using a solar cell panel in which a solar cell or a solar cell module is integrally formed as a panel, as a roof panel of the vehicle. As a result, increases in the number of parts, vehicle weight, and manufacturing cost and the like are able to be minimized. On one hand, when a solar cell panel is used as a roof panel, an existing strength member of the roof panel is eliminated, so the solar cell panel must have strength equivalent to that of a normal roof panel. If the substrate of the solar cell panel is made thicker, for example, in order to ensure the strength required for the solar cell panel, the weight will end up being that much heavier. Alternatively, if the material of the substrate of the solar cell panel is changed to a high strength and high performance material, the cost may end up being that much more.

In this way, technology for using a solar cell panel itself as the roof panel of a vehicle as described above is not established, so new technology needs to be developed.

### SUMMARY OF THE INVENTION

The invention thus provides a vehicle solar cell panel that satisfies various requirements for practical use, and can be used as a roof panel of a vehicle.

One aspect of the invention relates to a vehicle solar cell panel that is mounted to a vehicle provided with a roof rail. The vehicle solar cell panel includes a flange portion formed by a side edge portion of at least a portion of the vehicle solar cell panel being bent back toward a back side of a light receiving surface. A roof panel of the vehicle is formed by the flange portion being attached to the roof rail.

According to this aspect, the flange portion is formed by the side edge portion of the solar cell panel being bent back. Then, the solar cell panel is attached to the roof panel of the vehicle via this flange portion. Forming the flange portion by bending back the side edge portion in this way increases the sectional modulus when the solar cell panel is thought of as a beam supported at both ends in the longitudinal direction of the vehicle, for example. As a result, the rigidity and strength of the solar cell panel with respect to a load applied from the up-and-down direction of the vehicle increase. Therefore, a solar cell panel having a shape and strength comparable to those of a normal roof panel is able to be formed without excessively increasing the thickness of the panel or using extraordinarily high strength material. Consequently, the solar cell panel is able to be mounted to the vehicle as a roof panel, and as a result, increases in the number of parts, vehicle weight, and manufacturing cost and the like are able to be minimized.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view of a solar cell panel according to one example embodiment of the invention, shown installed on a vehicle;

FIG. 2 is an enlarged sectional view illustrating the structure of the solar cell according to the example embodiment of the invention;

FIG. 3 is a sectional view illustrating an example structure of the solar cell panel according to the example embodiment of the invention;

FIG. 4 is an enlarged sectional view showing the structure shown in FIG. 3 in detail;

FIG. 5 is a sectional view illustrating another example structure of the solar cell panel according to the example embodiment of the invention;

FIG. 6 is a sectional view of yet another example structure of the solar cell panel according to the example embodiment of the invention;

FIG. 7 is a sectional view of still another example structure of the solar cell panel according to the example embodiment of the invention; and

FIG. 8 is a sectional view of another example structure of the solar cell panel according to the example embodiment of the invention.

### DETAILED DESCRIPTION OF EMBODIMENTS

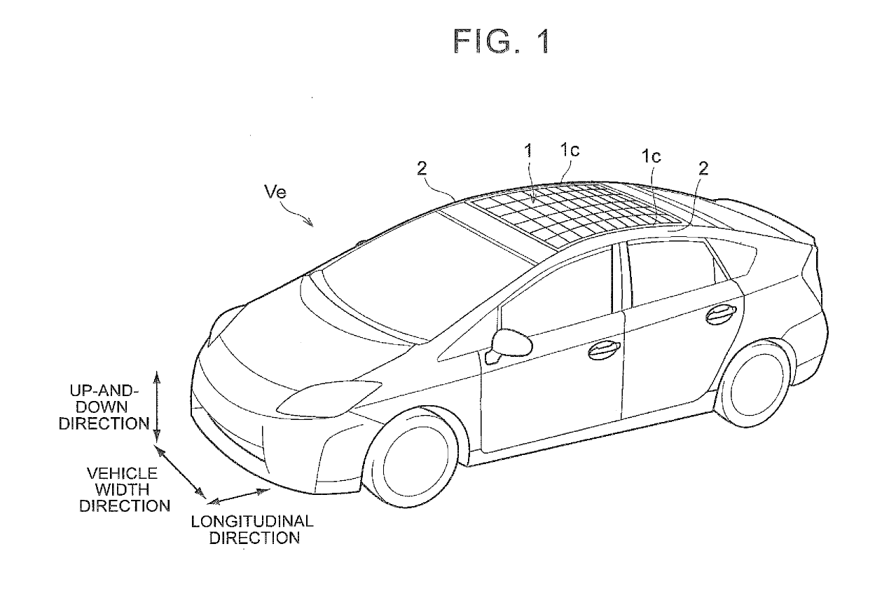

The invention will be described based on specific examples. The invention relates to the structure of a solar cell panel 1 mounted to a portion of a roof of a vehicle Ve, as shown in FIG. 1. This solar cell panel 1 is attached to roof rails 2 of the vehicle Ve, instead of an existing vehicle roof panel that is not equipped with a solar cell, as the roof panel of the vehicle Ve. That is, the solar cell panel 1 is formed in the same shape as the existing vehicle roof panel, and is configured so as to be able to be easily attached to the roof rails 2 of the vehicle Ve, in the same way in which an existing vehicle roof panel is attached to a vehicle body. In this example embodiment, portions such as the roof rails 2 that are provided in plurality may be referred to in the singular to simplify the description.

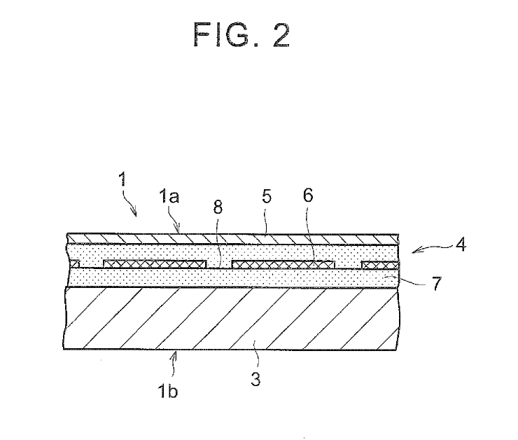

The solar cell panel 1 includes a substrate layer 3, a solar cell layer 4, and a surface protection layer 5, as shown in FIG. 2. Steel sheet, aluminum alloy sheet, or fiber-reinforced plastic or the like, for example, is used as the material of the substrate layer 3.

The solar cell layer 4 includes a plurality of solar cells 6, and filling material 7 within which these solar cells 6 are encapsulated. A transparent resin through which sunlight is able to pass, for example, is used as the filling material 7. Each solar cell 6 is itself a solar cell element, or is a basic unit of a solar cell in which a plurality of solar cell elements make up one unit. Any of a variety of types of existing solar cell elements, such as silicon elements or compound semiconductor elements, for example, may be used as the solar cell elements. The solar cells 6 are connected together by a lead wire 8.

The surface protection layer 5 is made of a transparent resin film through which sunlight is able to pass, or reinforced glass or the like, for example. This surface protection layer 5 may also be omitted if the filling material 7 of the solar cell layer 4 described above functions to protect the surface of the solar cell panel 1.

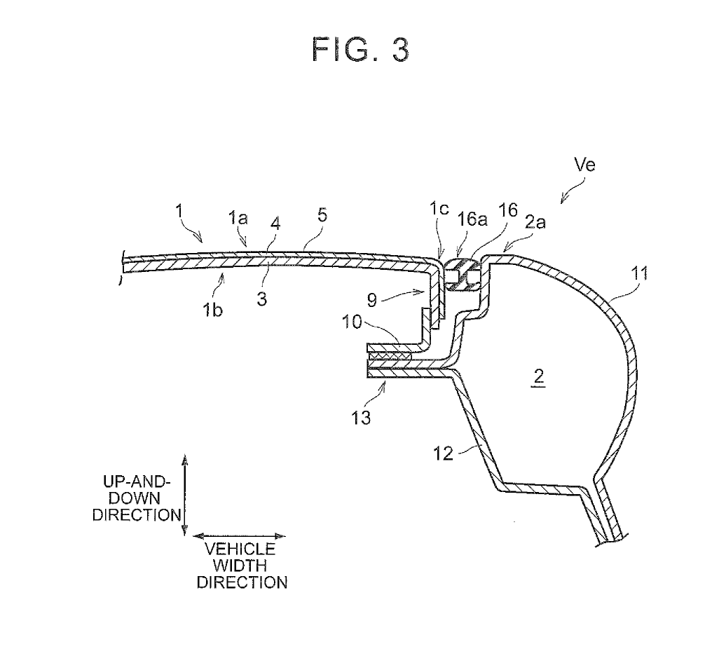

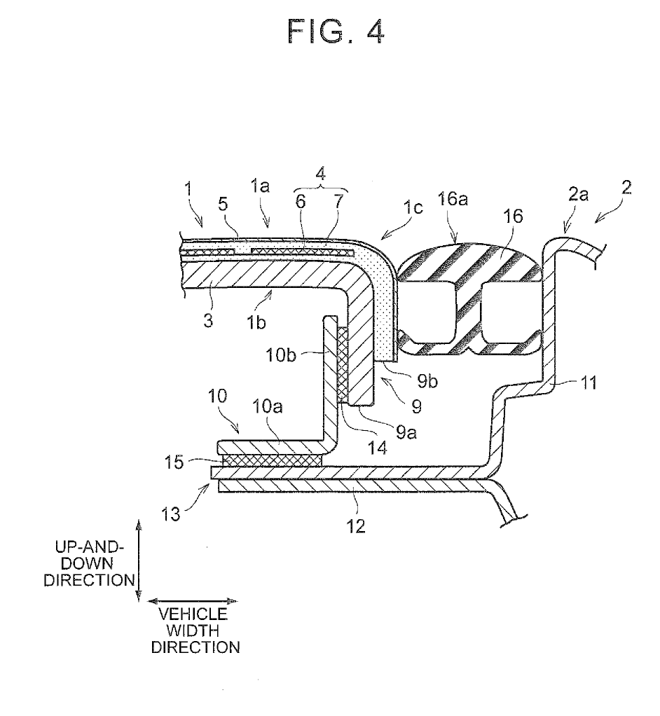

The solar cell panel 1 has a light receiving surface 1a and a back surface 1b. The light receiving surface 1a is a surface that faces upward in the up-and-down direction when the solar cell panel 1 is mounted to the vehicle Ve, and becomes a design surface of the vehicle Ve. The back surface 1b is a surface on the side opposite the light receiving surface 1a, and is formed by the substrate layer 3. Also, a flange portion 9 is formed by a side edge portion 1c that is positioned on both ends in the vehicle width direction when the solar cell panel 1 is mounted to the vehicle Ve, being bent back toward the back surface 1b side. In the example shown in FIGS. 3 and 4, the flange portion 9 is formed by the side edge portion 1c being bent back toward the back surface 1b side at a substantially right angle with respect to the light receiving surface 1a.

The flange portion 9 is formed in particular by the substrate layer 3, the surface protection layer 5, and a portion of the solar cell layer 4 that does not include the solar cells 6, at the side edge portion 1c, being bent toward the back surface 1b side. Typically, the solar cells 6 are difficult to bend, but with this solar cell panel 1, the portion that is bent back to form the flange portion 9 does not include the solar cells 6, as described above. Therefore, the side edge portion 1c can be easily bent, so the flange portion 9 is able to be easily formed.

Also, in the solar cell layer 4 of this solar cell panel 1, the solar cells 6 are arranged up to or close to a boundary between the light receiving surface 1a and the flange portion 9, without them being included in the bent portion of the side edge portion 1c as described above. That is, the solar cells 6 are arranged along as wide an area as possible on the light receiving surface 1a. Therefore, the roof portion of the vehicle Ve is able to be effectively utilized, so the area that is able to generate power by the solar cell panel 1 is able to be as wide as possible.

The solar cell panel 1 structured as described above is attached to the roof rail 2 of the vehicle Ve. More specifically, as shown in FIGS. 3 and 4, the flange portion 9 formed on both ends of the solar cell panel 1 in the vehicle width direction is attached, via a mounting member 10, to a side member flange 13 of the roof rail 2 that is formed by an outside side member 11 and an inside side member 12.

The mounting member 10 is made of L-shaped steel or aluminum alloy or the like, for example. Also, the mounting member 10 has a first flange portion 10a that is fixed to the roof rail 2, and a second flange portion 10b that protrudes upward in the up-and-down direction of the vehicle Ve from the roof rail 2 when the mounting member 10 is fixed to the side member flange 13.

The second flange portion 10b of the mounting member 10 is fixed to the flange portion 9 of the, solar cell panel 1. The second flange portion 10b may be fixed to the flange portion 9 by a joining method such as adhesion, welding, or bolt fastening, for example. In the example shown in FIGS. 3 and 4, the second flange portion 10b is fixed to the flange portion 9 using an adhesive 14.

The first flange portion 10a of the mounting member 10 is fixed to the side member flange 13 of the roof rail 2. The first flange portion 10a may be fixed to the side member flange 13 by a joining method such as adhesion, welding, or bolt fastening, for example. In the example shown in FIGS. 3 and 4, the first flange portion 10a is fixed to the side member flange 13 using an adhesive 15.

The mounting member 10 is fixed beforehand to the flange portion 9 of the solar cell panel 1 as described above. Therefore, when mounting the solar cell panel 1 to the vehicle Ye, the solar cell panel 1 is able to be mounted to the vehicle Ve by lowering the solar cell panel 1 straight down from above the roof rail 2 of the vehicle Ve and placing it onto the roof rail 2.

Also, the mounting member 10 is fixed to the flange portion 9 so as to be positioned on the back surface 1b side of the flange portion 9 of the solar cell panel 1. Therefore, a joining portion of the flange portion 9 and the back surface 1b of the mounting member 10 is covered by the flange portion 9 and thus shielded from the outside. Consequently, rainwater and the sun's rays that come in from outside are inhibited from directly striking the mounting member 10. As a result, degradation and corrosion of the mounting member 10 are inhibited, so the durability of the mounting member 10 is able to be improved.

Also, when the solar cell panel 1 is in a state attached to the roof rail 2, tip end portions 9a and 9b of the flange portion 9 are offset upward with respect to the side member flange 13 of the roof rail 2 in the up-and-down direction of the vehicle Ve. That is, the solar cell panel 1 is attached to the roof rail 2 in such a way that the tip end portions 9a and 9b of the flange portion 9 do not abut against the side member flange 13. A space between the roof rail 2 and the flange portion 9, and above the side member flange 13, serves as a water drain for draining water in the longitudinal direction of the vehicle Ve, when water gets in between the roof rail 2 and the flange portion 9. In contrast to this, the tip end portions 9a and 9b to be inhibited from becoming immersed in water by the tip end portions 9a and 9b of the flange portion 9 being offset upward with respect to the side member flange 13 as described above. As a result, degradation and corrosion of the tip end portions 9a and 9b are inhibited, so the durability of the solar cell panel 1 is able to be improved.

Moreover, when the solar cell panel 1 is in a state attached to the roof rail 2, the light receiving surface 1a of the solar cell panel 1 and an uppermost surface 2a of the roof rail 2 in the up-and-down direction of the vehicle Ve are positioned at the same height or substantially, the same height in the up-and-down direction of the vehicle Ve. Also, a molding 16 is attached between the light receiving surface 1a and the uppermost surface 2a, or more specifically, between the flange portion 9 of the solar cell panel 1 and the outside side member 11 of the roof rail 2. The molding 16 is a member that shields the flange portion 9 from the outside while the solar cell panel 1 is attached to the roof rail 2, and is made of rubber or resin or the like, for example. An uppermost surface 16a of this molding 16 in the up-and-down direction of the vehicle Ve is also positioned at substantially the same height in the up-and-down direction of the vehicle Ve as the light receiving surface 1a and the uppermost surface 2a of the roof rail 2 Therefore, a design surface of a roof portion of the vehicle Ve is able to be formed by the solar cell panel 1 and the roof rail 2 without there being a large step therebetween (i.e., between the solar cell panel 1 and the roof rail 2). Thus, the design of the roof portion of the vehicle Ve is able to be good. Also, foreign matter is able to be inhibited from remaining between the solar cell panel 1 and the roof rail 2.

In this way, the solar cell panel 1 has the flange portion 9 formed by the side edge portion 1c being bent back toward the back surface 1b side. Also, the solar cell panel 1 is attached to the roof rail 2 of the vehicle Ve via the flange portion 9 and the mounting member 10. Forming the flange portion 9 by bending the side edge portion 1c back in this way increases the sectional modulus of the solar cell panel 1, which increases the rigidity and strength of the solar cell panel 1 a corresponding amount. Therefore, the solar cell panel 1 having a shape and strength comparable to those of an existing vehicle roof panel is able to be formed without increasing the thickness of the panel or using expensive high strength material. Hence, the solar cell panel 1 is able to be mounted to the vehicle Ve as an existing vehicle roof panel. As a result, increases in the number of parts, vehicle weight, and manufacturing cost and the like are able to be minimized.

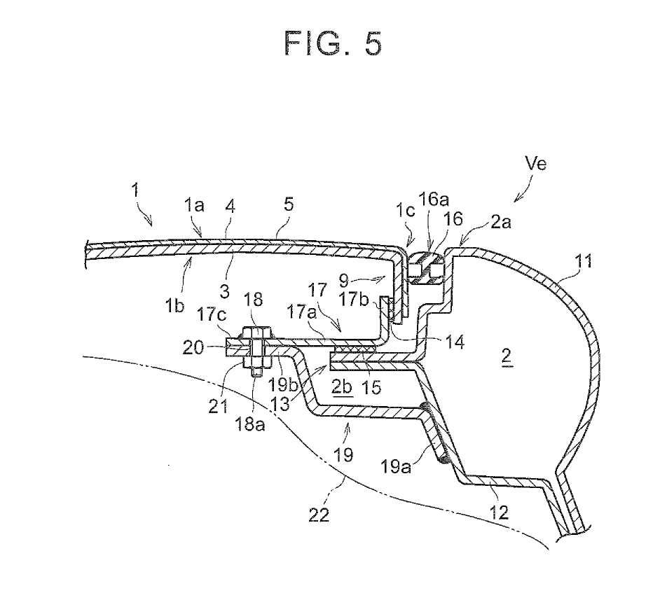

FIGS. 5, 6, 7, and 8 are views of other configuration examples of the solar cell panel 1 of the invention. With all of the solar cell panels 1 shown in FIGS. 5, 6, 7, and 8, the flange portion 9 is formed by the side edge portion 1c of the solar cell panel 1 being bent back toward the back surface 1b side. Also, the solar cell panel 1 is attached to the roof rail 2 of the vehicle Ve via this flange portion 9. Therefore, with all of the solar cell panels 1 shown in FIGS. 5, 6, 7, and 8, the solar cell panel 1 having a shape and strength comparable to those of an existing vehicle roof panel is able to be formed without increasing the thickness of the panel or using expensive high strength material, similar to the solar cell panel 1 having the structure shown in FIGS. 3 and 4 described above.

With the solar cell panel 1 shown in FIG. 5, the flange portion 9 is attached to the side member flange 13 of the roof rail 2 via a mounting member 17. More specifically, the mounting member 17 is made of an aluminum alloy or steel such as angle steel, for example. Also, the mounting member 17 has a first flange portion 17a that is fixed to the roof rail 2, and a second flange portion 17b that protrudes upward from the roof rail 2 in the up-and-down direction of the vehicle Ve while the mounting member 17 is fixed to the side member flange 13.

The second flange portion 17b of the mounting member 17 is fixed to the flange portion 9 of the solar cell panel 1. The second flange portion 17b may be fixed to the flange portion 9 by a joining method such as adhesion, welding, or bolt fastening, for example. In the example shown in FIG. 5, the second flange portion 17b is fixed to the flange portion 9 using an adhesive 14. Therefore, in the example shown in FIG. 5, the flange portion 9 of the solar cell panel 1 is attached to the roof rail 2 via the second flange portion 17b that protrudes above the mounting member 17 that is fixed to the roof rail 2 so as to protrude upward from the roof rail 2 in the up-and-down direction of the vehicle Ve.

The first flange portion 17a of the mounting member 17 is fixed to the side member flange 13 of the roof rail 2. The first flange portion 17a may be fixed to the side member flange 13 by a joining method such as adhesion, welding, or bolt fastening, for example. In the example shown in FIG. 5, the first flange portion 17a is fixed to the flange portion 9 using an adhesive 15.

Also, a tip end portion 17c is formed protruding out from the side member flange 13 on the first flange portion 17a of the mounting member 17 while fixed to the side member flange 13. A bolt 18 is fixed to this tip end portion 17c in such a manner that a tip end 18a of a threaded portion of the bolt 18 passes through the first flange portion 17a and points downward in the up-and-down direction of the vehicle Ve. The bolt 18 may be fixed to the first flange portion 17a by a joining method such as adhesion or welding, for example. In the example shown in FIG. 5, the bolt 18 is fixed to the first flange portion 17a by welding.

Furthermore, a mounting member 19 is attached to the inside side member 12 of the roof rail 2. This mounting member 19 is made of an aluminum alloy or steel that has been formed into a predetermined shape, for example. Also, the mounting member 19 has a first flange portion 19a that is fixed to the inside side member 12, and a second flange portion 19b.

The first flange portion 19a may be fixed to the inside side member 12 by a joining method such as adhesion, welding, or bolt fastening, for example. In the example shown in FIG. 5, the first flange portion 19a is fixed to the inside side member 12 by welding.

A bolt hole 20 through which the threaded portion of the bolt 18 is able to pass when the mounting member 17 described above is fixed to the side member flange 13 and the mounting member 19 is fixed to the inside side member 12, is formed in the second flange portion 19b.

The mounting member 17 is fixed to the flange portion 9 of the solar cell panel 1 in advance, while the bolt 18 is fixed to the tip end portion 17c as described above. Also, the mounting member 19 is fixed to the roof rail 2 in advance, while the bolt hole 20 is open in the second flange portion 19b as described above. Therefore, the bolt 18 of the mounting member 17 and the bolt hole 20 of the mounting member 19 serve to positioners when mounting the solar cell panel 1 to the vehicle Ve. As a result, the solar cell panel 1 is able to be easily mounted to the vehicle Ve.

Then, the solar cell panel 1 is lowered straight down from above the roof rail 2 of the vehicle Ve and placed onto the roof rail 2, and then with the threaded portion of the bolt 18 passing through the bolt hole 20, the mounting member 17 and the mounting member 19 are fastened together by the bolt 18 and a nut 21. By fastening together the mounting member 17 that is fixed to the side member flange 13, and the mounting member 19 that is fixed to the inside side member 12 in this way, another closed cross-section 2b is able to be added to the cross-section of the roof rail 2. As a result, the rigidity of the vehicle body is able to be improved.

A fastening portion of the bolt 18 and the nut 21 extends out toward the center of the vehicle Ve, substantially parallel to the side member flange 13 in the vehicle width direction of the vehicle Ve. Therefore, the bolt fastening portion will not advance downward in the up-and-down direction of the vehicle Ve. That is, as shown in FIG. 5, the height position of an interior ceiling 22 of the vehicle Ve in the up-and-down direction of the vehicle Ve will not come down toward the vehicle cabin due to the bolt fastening portion. Therefore, cabin interior space of the vehicle Ve is able to be ensured.

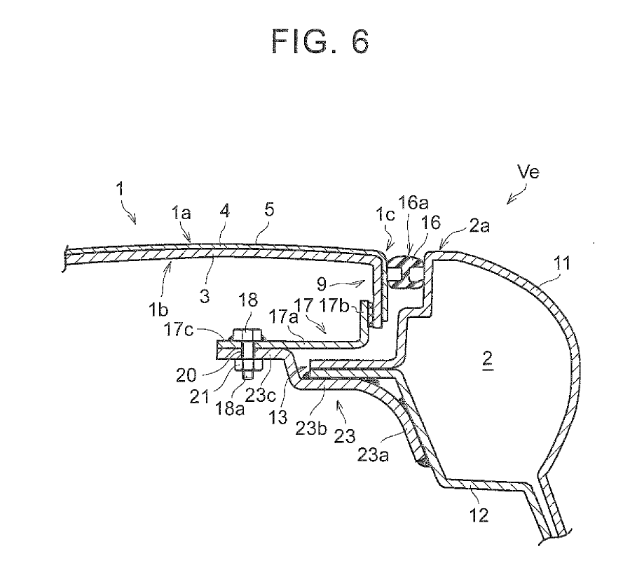

The flange portion 9 of the solar cell panel 1 shown in FIG. 6 is attached to the side member flange 13 of the roof rail 2 via the mounting member 17 and a mounting member 23. Also, the bolt 18 is fixed to the tip end portion 17c of the first flange portion 17a of the mounting member 17.

Meanwhile, the mounting member 23 is attached to the inside side member 12 of the roof rail 2. The mounting member 23 is made of an aluminum alloy or steel that has been formed into a predetermined shape, for example, similar to the mounting member 19 shown in FIG. 5 described above. Also, the mounting member 23 has a first flange portion 23a and a base portion 23b that are fixed to the inside side member 12, and a second flange portion 23c.

The first flange portion 23a may be fixed to the inside side member 12 by a joining method such as adhesion, welding, or, bolt fastening, for example. In the example shown in FIG. 6, the first flange portion 23a is fixed to the inside side member 12 by welding.

The base portion 23b may also be fixed to the inside side member 12 by a joining method such as adhesion, welding, or bolt fastening, for example, similar to the first flange portion 23a. In the example shown in FIG. 6, the base portion 23b is fixed to the inside side member 12 by welding.

A bolt hole 20 is fowled in the second flange portion 23c, similar to the second flange portion 19b of the mounting member 19 shown n FIG. 5 described above.

In this way, with the structure shown in FIG. 6, the mounting member 23 is fixed to the inside side member 12 by the base portion 23b in addition to the first flange portion 23a. Therefore, the distance from the joining portion of the mounting member 23 and the roof rail 2 to the bolt fastening portion of the mounting member 23 and the mounting member 17 is shorter than it is with the structure shown in FIG. 5 described above. That is, the structure is such that the load applied to the joining portion of the mounting member 23 and the roof rail 2 is reduced. As a result, the durability and reliability of the joining portion of the mounting member 23 and the roof rail 2 are able to be improved.

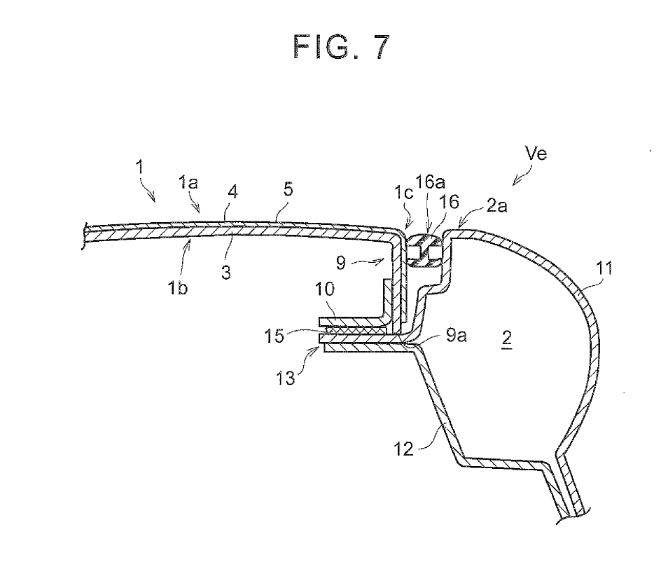

The solar cell panel 1 shown in FIG. 7 has basically the same structure as the solar cell panel 1 shown in FIGS. 3 and 4 described above. The difference between them is that with the solar cell panel 1 shown in FIG. 7, the solar cell panel 1 is attached to the roof rail 2 in such a manner that a tip end portion 9a of the flange portion 9 abuts against the side member flange 13 of the roof rail 2.

In this way, with the structure shown in FIG. 7, the solar cell panel 1 is able to be positioned in the up-and-down direction of the vehicle Ve when attaching the solar cell panel 1 to the roof rail 2, by having the tip end portion 9a of the flange portion 9 abut against the side member flange 13. Therefore, the solar cell panel 1 is able to be easily mounted to the vehicle Ve. Also, as shown in FIG. 7, when adhering (i.e., fixing) the mounting member 10 to the side member flange 13 with an adhesive 15, the adhesive 15 is able to be inhibited from protruding on the roof rail 2 side (i.e., the right side in FIG. 7) by the tip end portion 9a of the flange portion 9 abutting against the side member flange 13.

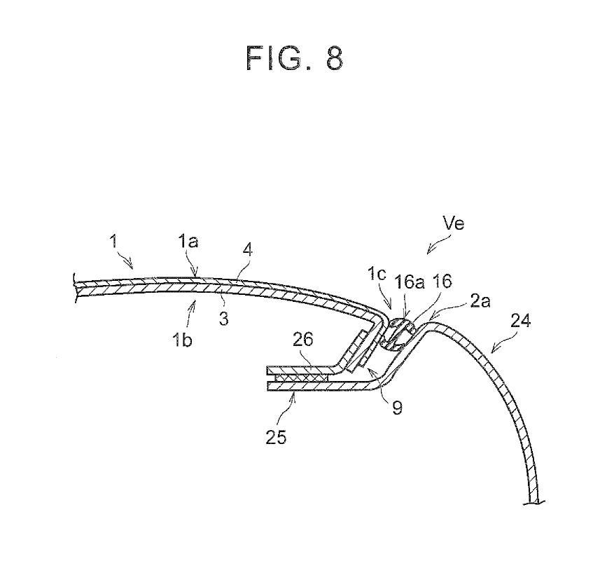

The structure of the solar cell panel 1 of the invention may also similarly be applied with a vehicle Ve having a roof rail 24 and a side member flange 25 that are shaped as shown in FIG. 8 as well. That is, the flange portion 9 is formed by the side edge portion 1c of the solar cell panel 1 being bent back toward the back surface 1b side following the shape of the roof rail 24 and the side member flange 25. Then, the flange portion 9 is fixed to the side member flange 25 via a mounting member 26 that has been formed into a predetermined shape that matches the shapes of the roof rail 24 and the side member flange 25.

In the specific examples described above, the solar cell panel 1 is attached to the roof rails 2 (or the roof rails 24) that are arranged at both ends of a roof portion of the vehicle Ve in the vehicle width direction, but the solar cell panel 1 of the invention may also be attached to roof rails that are arranged at both ends of a roof portion of the vehicle Ve in the longitudinal direction by a structure similar to that described in the specific examples described above.

What is claimed is:

1. A vehicle solar cell panel that is mounted to a vehicle provided with a roof rail, comprising:
a flange portion formed by a side edge portion of at least a portion of the vehicle solar cell panel being bent back toward a back side of a light receiving surface,
wherein a roof panel of the vehicle is formed by the flange portion being attached to the roof rail.

2. The vehicle solar cell panel according to claim 1, further comprising:
a base layer that forms a surface on the back side of the light receiving surface; and
a solar cell layer that includes a solar cell and filling material within which the solar cell is encapsulated,
wherein the flange portion is formed by the base layer and a portion of the solar cell layer that does not include the solar cell, at the side edge portion, being bent back.

3. The solar cell panel according to claim 1, wherein
the flange portion is attached to the roof rail via a portion that protrudes above, in a up-and-down direction of the vehicle, a mounting member that is fixed to the roof rail, so as to protrude upward in the vehicle up-and-down direction from the roof rail; and
the flange portion and the mounting member are fixed such that the mounting member is positioned on the back side of the light receiving surface of the flange portion.

4. The solar cell panel according to claim 1, wherein
the flange portion is attached to the roof rail such that the light receiving surface and an uppermost surface of the roof rail in a up-and-down direction of the vehicle are positioned at the same height in the up-and-down direction; and
a molding that shields the flange portion from outside is attached between the light receiving surface and the uppermost surface.
